(19) United States
(12) Patent Application Publication
(10) Pub. No.: US 2011/0007748 A1
(43) Pub. Date: Jan. 13, 2011

(54) METHOD, SYSTEM AND APPARATUS FOR OPTIMIZING ROUTES

(75) Inventors: Yu YIN, Shenzhen (CN); Qing Zhou, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD, Shenzhen (CN)

(21) Appl. No.: 12/887,277

(22) Filed: Sep. 21, 2010

Related U.S. Application Data
(63) Continuation of application No. PCT/CN2009/070501, filed on Feb. 23, 2009.

(30) Foreign Application Priority Data
Mar. 31, 2008 (CN) 200810090243.3

(51) Int. Cl. H04L 12/56

(52) U.S. Cl. 370/401

(57) ABSTRACT

A method for optimizing routes includes: receiving a route optimization request that includes a network address reallocation indication, wherein the route optimization request is sent by a User Equipment (UE) when a first Packet Data Network (PDN) connection exists between the UE and an old gateway; and triggering establishment of a second PDN connection between the UE and a new gateway according to the network address reallocation indication. Computer program products and computer-readable storage media corresponding to the method for optimizing routes, an MME, a system for optimizing routes, and a UE are also disclosed herein. Through the embodiments of the present invention, an after-route-optimization PDN connection is established in the process of route optimization, and two PDN connections can be established for one access point at the same time.

### CROSS-REFERENCE TO RELATED APPLICATIONS

This application is a continuation of International Application No. PCT/CN2009/070501, filed on Feb. 23, 2009, which claims priority to Chinese Patent Application No. 200810090243.3, filed on Mar. 31, 2008, both of which are hereby incorporated by reference in their entireties.

### FIELD OF THE INVENTION

The present invention relates to communication technologies, and in particular, to a method, a system, and an apparatus for optimizing routes.

### BACKGROUND OF THE INVENTION

Mobile communication networks are divided into two parts: Circuit Switched (CS) domain and Packet Switched (PS) domain. The CS domain bears traditional CS voice services, and the PS domain provides packet services based on packet switching. For the PS domain, a Local Break Out (LBO) concept is introduced to optimize routes and reduce data transmission delay. LBO means that the data gateway in the visited area of the user allocates the Internet Protocol (IP) address, and data is routed from the visited area to the external data network directly, without passing through the area outside the visited area.

Data is transmitted through a Packet Data Network (PDN) connection. Therefore, User Equipment (UE) needs to send a PDN Connectivity request to establish a PDN connection to transmit data. A solution to processing a PDN Connectivity request in the prior art is: The network receives a new PDN Connectivity request which requests to establish a PDN connection after route optimization (hereafter referred to as after-route-optimization PDN connection). If the Access Point Name (APN) of the PDN corresponding to the UE that sends the new PDN Connectivity request is the same as the APN of the existing PDN connection, the network rejects the new PDN Connectivity request.

In the process of developing the present invention, the inventor finds at least the following drawbacks in the prior art: When a PDN connection already exists, if the APN corresponding to the received new PDN Connectivity request is the same as the APN of the existing PDN connection, the network rejects the new PDN Connectivity request, and therefore, in the process of route optimization, it is impossible to establish an after-route-optimization PDN connection for the APN, or establish two PDN connections for one APN at the same time.

### SUMMARY OF THE INVENTION

The embodiments of the present invention provide a method, a system, and an apparatus for optimizing routes. Through the technical solution under the present invention, an after-route-optimization PDN connection is established in the process of route optimization, and two PDN connections are established for one access point at the same time.

A method for optimizing routes provided in an embodiment of the present invention includes:

receiving a route optimization request that includes a network address reallocation indication, where the route optimization request is sent by a UE when a first PDN connection exists between the UE and an old gateway; and

triggering establishment of a second PDN connection between the UE and a new gateway according to the network address reallocation indication.

A computer program product is provided in an embodiment of the present invention. The computer program product includes computer program codes. When being executed by a computer, the computer program codes make the computer perform any step of the method for optimizing routes.

A computer-readable storage medium is provided in an embodiment of the present invention for storing computer program codes. When being executed by a computer, the computer program codes make the computer perform any step of the method for optimizing routes.

A Mobility Management Entity (MME) provided in an embodiment of the present invention includes:

a request receiving unit, configured to receive a route optimization request that includes a network address reallocation indication, where the route optimization request is sent by a UE when a first PDN connection exists between the UE and an old gateway; and

a connection triggering unit, configured to trigger establishment of a second PDN connection between the UE and a new PDN Gateway (PGW) according to the network address reallocation indication received by the request receiving unit.

A system for optimizing routes provided in an embodiment of the present invention includes:

an old gateway, configured to establish a first PDN connection to a UE;

an MME, configured to receive a route optimization request that includes a network address reallocation indication, where the route optimization request is sent by the UE when a first PDN connection exists between the UE and the old gateway; and send a trigger message according to the network address reallocation indication; and

a new gateway, configured to establish a second PDN connection to the UE according to the trigger message sent by the MME.

A UE provided in an embodiment of the present invention includes:

a request sending unit, configured to send a route optimization request that includes a network address reallocation indication when a first PDN connection to the old gateway exists; and

a connection establishing unit, configured to establish a second PDN connection to the new gateway after the request sending unit sends the route optimization request.

The technical solution under the present invention reveals that: After the route optimization request that includes the network address reallocation indication is received, a second PDN connection is established according to the network address reallocation indication. Therefore, in the process of route optimization, the after-route-optimization second PDN connection is established, and the existing first PDN connection is reserved at the time of establishing the second PDN connection; two PDN connections can be established for one access point, the service of the UE can be handed over to the new gateway through the second PDN connection. In this way, the service continuity is ensured in the process of route optimization.

### BRIEF DESCRIPTION OF THE DRAWINGS

FIG. 1 is a flowchart of a method for optimizing routes in Embodiment 1 of the present invention;

FIG. 2 is a signaling flowchart of a method for optimizing routes in Embodiment 2 of the present invention;

FIG. 3 is a signaling flowchart of a method for optimizing routes in Embodiment 3 of the present invention;

FIG. 4 is a signaling flowchart of a method for optimizing routes in Embodiment 4 of the present invention;

FIG. 5 is a signaling flowchart of a method for optimizing routes in Embodiment 5 of the present invention;

FIG. 6 is a signaling flowchart of a method for optimizing routes in Embodiment 6 of the present invention;

FIG. 7 shows a structure of a UE in an embodiment of the present invention;

FIG. 8 shows a structure of an MME in Embodiment 1 of the present invention;

FIG. 9 shows a structure of an MME in Embodiment 2 of the present invention;

FIG. 10 shows a structure of an MME in Embodiment 3 of the present invention; and

FIG. 11 shows a structure of a system for optimizing routes in an embodiment of the present invention.

### DETAILED DESCRIPTION OF THE EMBODIMENTS

To make the technical solution, objectives and merits of the present invention clearer, the following describes the embodiments of the present invention in detail with reference to the accompanying drawings.

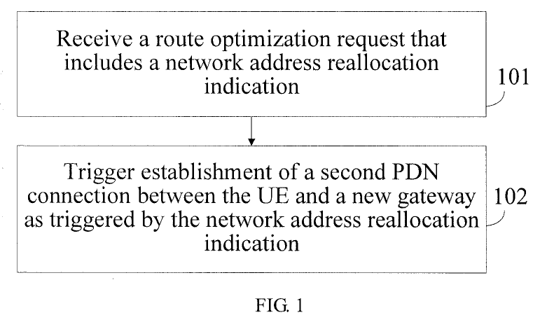

A method for optimizing routes provided in an embodiment of the present invention is described. FIG. 1 is a flowchart of a method for optimizing routes provided in Embodiment 1 of the present invention. The method includes the following steps:

Step 101: Receive a route optimization request that includes a network address reallocation indication.

The route optimization request is sent when a first PDN connection exists between the UE and the old gateway. When the location of the UE changes, the old gateway may not be optimal. Therefore, the UE may send a route optimization request to optimize the route. In this way, services of the UE can be handed over to an optimal gateway. To make the network know information about the PDN that needs to initiate route optimization, the route optimization request includes an identifier of the PDN, for example, APN and Linked Bearer Identifier (LBI). The identifier of the PDN may be preconfigured on the UE, or provided by a network-side entity such as an MME. For example, when the network determines that the UE enters the area that requires route optimization, the network submits the identifier (such as APN or LBI) of the PDN that needs to initiate route optimization to the UE.

The gateway is designed for accessing a data network, and varies with the type of network. For example, in a System Architecture Evolution (SAE) network, the gateway may be an access gateway for the UE to access the PDN, such as a PGW.

The UE may send a route optimization request according to the MME. If the MME determines that the location of the UE has changed and the old PGW of the UE is not the most appropriate, the MME may notify the UE that the UE needs to initiate route optimization. Specifically, a Tracking Area Update (TAU) Accept message may be sent to the UE to let the UE initiate tracking area update. The UE decides whether and when to send a route optimization request according to the notification from the MME, for example, to send the route optimization request immediately or later, or not send a route optimization request.

Nevertheless, the UE may initiate route optimization and send a route optimization request as indicated by a user indication or service application indication.

The route optimization request sent by the UE may be a PDN Connectivity request. The network address reallocation indication carried in this request indicates that the UE needs to initiate route optimization, and instructs the network to reallocate a network address. The route optimization request includes an identifier (such as APN and LBI) of the PDN, indicating the PDN network to be optimized by the UE. If the route optimization request is a PDN Connectivity request or another existing request message, the network address reallocation indication may be an independent parameter in the request, for example, “optimize indication”. Alternatively, an existing parameter in the request may be extended to carry the network address reallocation indication. Optionally, the route optimization request sent by the UE may carry the APN corresponding to the UE. In this case, the network address reallocation indication may be sent through a structured APN. For example, if the APN is “cmims”, in the case of route optimization, the UE may set the APN to “cmims.opt” in the route optimization request, indicating that the UE needs to initiate route optimization and expecting the network to reallocate an IP address.

Nevertheless, the route optimization request sent by the UE may be a new request message such as a second PDN Connectivity request message. The request message includes a PDN identifier such as APN and LBI. As a new request message, the message itself without carrying any additional information may serve as a redirection indication.

Step 102: Triggering establishment of a second PDN connection between the UE and a new gateway according to the network address reallocation indication.

The first PDN connection and the second PDN connection are in the same PDN. Therefore, the first PDN connection corresponds to the same access point as the second PDN connection, namely, the first PDN connection has the same APN as the second PDN connection.

At the time of establishing the second PDN connection, the new gateway allocates a new network address to the UE. Assuming that the gateway is a PGW, the process of establishing a second PDN connection in an embodiment of the present invention is as follows:

According to a network address reallocation indication, the MME selects a new gateway for the UE, and sends a trigger message that includes information about the selected new gateway. An access control entity receives the trigger message, knows the new gateway information, and sends a connection establishment request to the new gateway. After receiving the connection establishment request, the new gateway establishes the second PDN connection. The access control entity varies with the type of network. For example, the access control entity may be Serving Gateway (SGW), evolved Packet Data Gateway (ePDG), Access Service Network-Gateway (ASN-GW), or Serving GPRS Support Node (SGSN).

If the access control entity is an SGW, the process of establishing a second PDN connection in this embodiment may be: The MME selects a new PGW for the UE according to the network address reallocation indication, and sends a PDN connection establishment request as a trigger message to the SGW; the PDN connection establishment request includes the information about the selected new PGW; after receiving the PDN connection establishment request, the SGW sends a connection establishment request to the new PGW; after receiving the connection establishment request from the SGW, the new PGW establishes the second PDN connection. At the time of establishing the second PDN, the network allocates a new network address to the UE. Specifically, the PGW or a Dynamic Host Configuration Protocol (DHCP) server in the network allocates a new network address to the UE as requested by the UE, and sends the new network address to the UE.

After the second PDN connection is established, the first PDN connection may be released directly, or the first PDN connection is released according to a policy. Preferably, the first PDN connection is released according to a policy to ensure service continuity of the UE in the process of route optimization.

In this embodiment, after the route optimization request that includes the network address reallocation indication is received, a second PDN connection is established according to the network address reallocation indication. In this way, in the process of route optimization, the after-route-optimization second PDN connection is established, and the existing first PDN connection is reserved at the time of establishing the second PDN connection; two PDN connections can be established for one access point. Therefore, the service of the UE can be handed over to the new gateway through the second PDN connection, and thus the service continuity is ensured in the process of route optimization.

Further, the following step may be performed before step 102:

determining whether the UE that sends the route optimization request is allowed to use LBO; performing step 102 only if the UE is allowed to use LBO, or rejecting the route optimization request of the UE if the UE has no right of LBO; or

determining whether a new gateway is better than the old gateway; performing step 102 only if the new gateway is better than the old gateway, or rejecting the route optimization request of the UE if the new gateway is not better than the old gateway, where “better” means that the UE obtains better services through a better gateway, for example, the gateway in the visited area is better than the gateway in the home area after the UE roams to the visited area, and the UE obtains better services if the UE accesses the network through the gateway in the visited area.

After the second PDN connection is established, the service of the UE may be handed over to the new gateway through the second PDN connection.

In step 102, the new gateway allocates a new network address of the second PDN connection to the UE. Therefore, the UE can hand the service over to the new gateway according to the new network address. Specifically, assuming that the UE is located in an IP Multimedia Core Network Subsystem (IMS) network and the gateway is a PGW, the UE may send a Session Initiation Protocol (SIP) reINVITE request to the network side in the process of an IMS session; the Session Description Protocol (SDP) information includes information about a media port of the IMS session, and the network address allocated by the current PGW of the media port of the IMS session is modified to a new network address, thus handing over the service from the current PGW to the new PGW.

After the service is handed over to the new PGW, the UE may release the first PDN connection to reduce occupation of system resources.

The release of the first PDN connection may be initiated by the UE; before the UE releases the first PDN connection, the network side may check whether the first PDN connection is released and release it if it has not been released. The release of the first PDN connection may be initiated by the release initiating unit such as SGW, PGW, and Policy Control and Charging Rules Function (PCRF). The PCRF may be a home PCRF (hPCRF) or visited area PCRF (vPCRF).

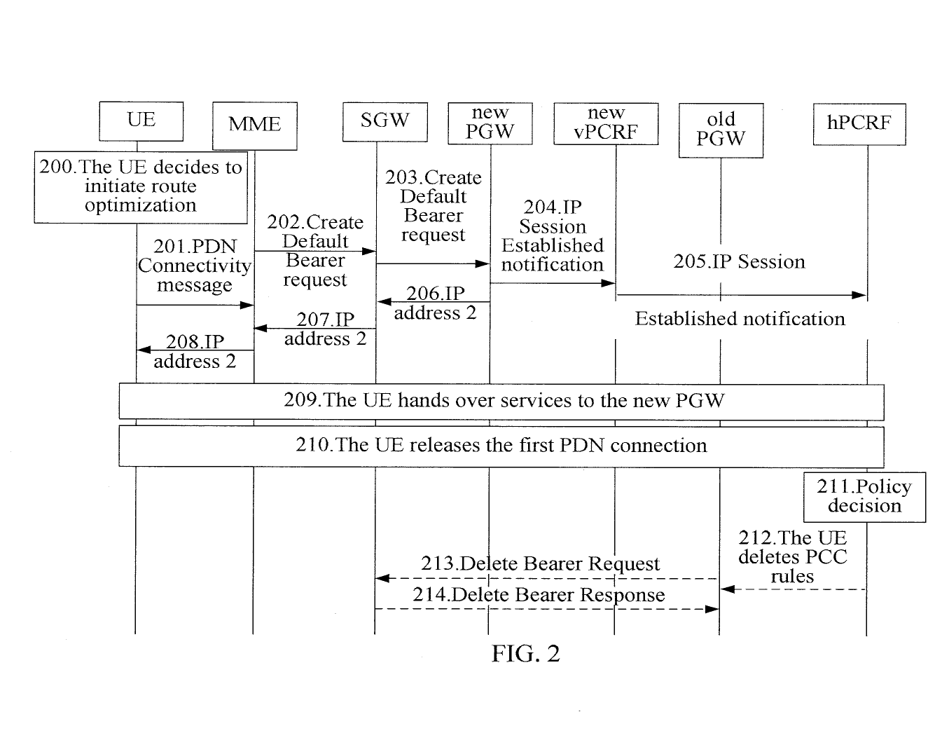

The following describes a method for optimizing routes provided in an embodiment of the present invention, assuming that the gateway is a PGW. FIG. 2 is a signaling flowchart of a method for optimizing routes provided in Embodiment 2 of the present invention. This embodiment deals with a scenario in which the UE initiates release of the first PDN connection and a scenario in which the hPCRF initiates release of the first PDN connection. The method includes the following steps:

Step 200: The UE decides to initiate route optimization.

At this time, the first PDN connection exists between the UE and the current PGW (old PGW); the network address of the UE may be IP address 1; the first PDN connection may be established in this way: The UE sends a PDN Connectivity request to the old PGW to obtain IP address 1, and the old PGW reports the foregoing information to the hPCRF through a vPCRF (old vPCRF) so that the hPCRF knows that the first PDN connection is established, whereupon the UE may use IP address 1 to implement services such as IMS and instant message.

Step 201: The UE sends a PDN Connectivity message as a route optimization request to the MME. This message includes a reallocation indication.

Step 202: The MME sends a Create Default Bearer request message to the access control entity “SGW”. The Create Default Bearer request message includes the reallocation indication and serves as a trigger message.

After receiving the PDN Connectivity request sent by the UE, the MME may determine whether the UE is allowed to use LBO, and reject the route optimization request if the UE has no right of LBO.

Further, the MME may determine whether a new gateway is better than the old PGW; and, if a new gateway is not better than the old PGW, the MME rejects the route optimization request.

If determining that a new gateway is better than the old PGW, the MME selects a new PGW better than the old PGW for the APN, and sends a PDN Connectivity request to the SGW. The PDN Connectivity request includes information about the new POW. In this embodiment, the PDN Connectivity request may be a Create Default Bearer request, but is not limited to a Create Default Bearer request.

Step 203: The SGW sends a Create Default Bearer message to the selected new POW.

After receiving the Create Default Bearer message, the SGW sends a PDN Connectivity request to the new PGW. The PDN Connectivity request varies with the type of interface protocol. For example, if the interface protocol between the SGW and the new PGW is CPRS Tunneling Protocol (GTP), the SGW sends a Create Default Bearer message described in this embodiment to the PGW; if the interface protocol between the SGW and the PGW is Proxy Mobile IP (PMIP) protocol, the SGW may send a Proxy Binding Update message to the PGW.

Step 204: The new PGW allocates a new network address to the UE. It is assumed that the new network address is IP address 2. The new PGW sends a notification message to the vPCRF (new vPCRF). The notification message may be an IP Session Established notification message indicating that the UE has established the second PDN connection.

When the PGW sends a notification message to the new vPCRF, if the interface protocol between the SGW and the new PGW is GTP, the PGW sends an IP Session Established notification that notifies to the vPCRF. If the interface protocol between the SGW and the PGW is PMIP, the SGW may send a notification message to the new vPCRF. The notification message may be an IP Session Established notification that notifies to the vPCRF. The PCRF may deliver the corresponding Policy and Charging Control (PCC) rules.

Step 205: The new vPCRF sends an IP Session Established notification message to the hPCRF so that the hPCRF knows that the UE has established the second PDN connection.

Step 206: The new PGW sends a message that includes IP address 2 to the SGW. Step 206 is performed after the new PGW allocates a new network address, namely, IP address 2, to the UE, and step 206 may be performed before, while or after the new PGW sends the IP Session Established message to the new vPCRF.

Step 207: The SGW sends a message that includes IP address 2 to the MME.

Step 208: The MME sends the message that includes IP address 2 to the UE.

Step 209: After receiving the message that includes IP address 2, the UE knows that the new PDN connection has been established, and the new network address is IP address 2. In this way, the service is handed over to the new PDN.

When the UE is located in different systems, the process of service handover varies with the type of the system. Taking an IMS system as an example, the UE may send a reINVITE request, in the IMS session, to the IMS network. The SDP information includes information about the media port of the IMS session, and the media port of the IMS session is modified from IP address 1 to IP address 2, thus handing over the service from the old PGW to the new PGW.

Step 210: The UE initiates release of the first PDN connection.

The UE may send a PDN Disconnect request that includes an LBI to request release of the PDN connection to the old PGW.

Further, if step 210 is not performed, namely, the UE does not initiate release of the first PDN connection, steps 211-214 may be performed to release the first PDN connection.

Step 211: The hPCRF makes a policy decision.

According to a local policy, the hPCRF makes a policy decision. It is assumed that the local policy is a time policy. After a period such as 12 hours, the hPCRF finds that two PDN connections still exist locally for the APN “cmims” of the UE. In this case, the hPCRF may perform the corresponding operations. For example, the hPCRF delivers a policy command to the old PGW to trigger the old PGW to delete the corresponding PCC rules.

Step 212: The hPCRF sends a message for deleting PCC rules to the old PGW.

Step 213: The old PGW sends a Delete Bearer Request message to the SGW.

Step 214: The SGW releases the corresponding resources, and sends a Delete Bearer Response message to the old PGW, thus releasing the first PDN connection.

In conclusion, in this embodiment, the UE sends a route optimization request that includes a network address reallocation indication, and the network establishes an after-route-optimization second PDN connection for the UE, and the existing first PDN connection is reserved while the second PDN connection is established. In this way, the existing data gateway and address are reserved when the service is provided through a new PGW. Therefore, the service continuity is ensured in the process of route optimization. In addition, the first PDN connection may be released after the UE hands the service over to the new PGW, thus releasing the system resources occupied by the UE and improving the utilization ratio of system resources.

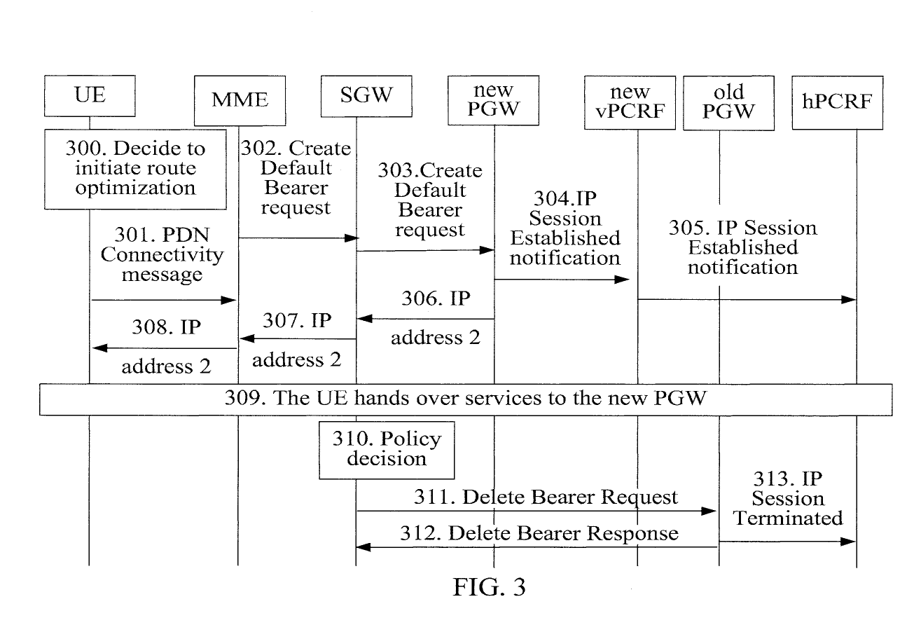

FIG. 3 is a flowchart of a method for optimizing routes provided in Embodiment 3 of the present invention. In this embodiment, the SGW initiates release of the first PDN connection. The method includes the following steps:

Step 300: The UE decides to initiate route optimization.

Step 301: The UE sends a PDN Connectivity message to the MME. This message includes a reallocation indication.

Step 302: The MME sends a Create Default Bearer message to the SGW. The Create Default Bearer message includes the reallocation indication and the information about the new PGW selected by the MME.

Step 303: The SGW sends a Create Default Bearer message to the selected new PGW.

Step 304: The new PGW allocates a new network address, namely, IP address 2, to the UE. The new PGW sends an IP Session Established notification message to the new vPCRF, indicating that the UE has established the second PDN connection.

Step 305: The new vPCRF sends an IP Session Established notification message to the hPCRF so that the hPCRF knows that the UE has established the second PDN connection.

Step 306: The new PGW sends a message that includes IP address 2 to the SOW. Step 206 is performed after the new PGW allocates a new network address, namely, IP address 2, to the UE, and step 206 may be performed before, while or after the new PGW sends the IP Session Established message to the new vPCRF.

Step 307: The SGW sends a message that includes IP address 2 to the MME.

Step 308: The MME sends the message that includes IP address 2 to the UE.

Step 309: After receiving the message that includes IP address 2, the UE knows that the new PDN connection has been established, and the new network address is IP address 2. In this way, the service is handed over to the new PGW.

Steps 300-309 are similar to steps 200-209.

Step 310: The SGW makes a policy decision.

According to a local policy, the SGW makes a policy decision. It is assumed that the local policy is a time policy. After a period such as 12 hours, the SGW finds that two PDN connections still exist locally for the APN “cmims” of the UE. In this case, the SGW may perform the corresponding operations. For example, a disconnection trigger message is sent to the old PGW to delete the first PDN connection.

In this embodiment, it may be the MME that makes the policy decision. The MME makes a decision according to the local policy. If the MME finds that two PDN connections exist locally for one APN of the UE, the MME may send a disconnection trigger message to the SGW to delete the first PDN connection.

Step 311: The SGW sends a Delete Bearer Request message as a disconnection trigger message to the old POW.

Step 312: The old PGW releases the corresponding resources, and sends a Delete Bearer Response message to the SGW, thus releasing the first PDN connection.

Step 313: After releasing the corresponding resources, the old PGW sends an IP Session Terminated message to the hPCRF so that the hPCRF knows that the first PDN connection is released.

In conclusion, in this embodiment, the UE sends a route optimization request that includes a network address reallocation indication, and the network establishes an after-route-optimization second PDN connection for the UE, and the existing first PDN connection is reserved while the second PDN connection is established. In this way, the existing data gateway and address are reserved when the service is provided through a new PGW. Therefore, the service continuity is ensured in the process of route optimization. In addition, the first PDN connection may be released after the UE hands the service over to the new PGW, thus releasing the system resources occupied by the UE and improving the utilization ratio of system resources.

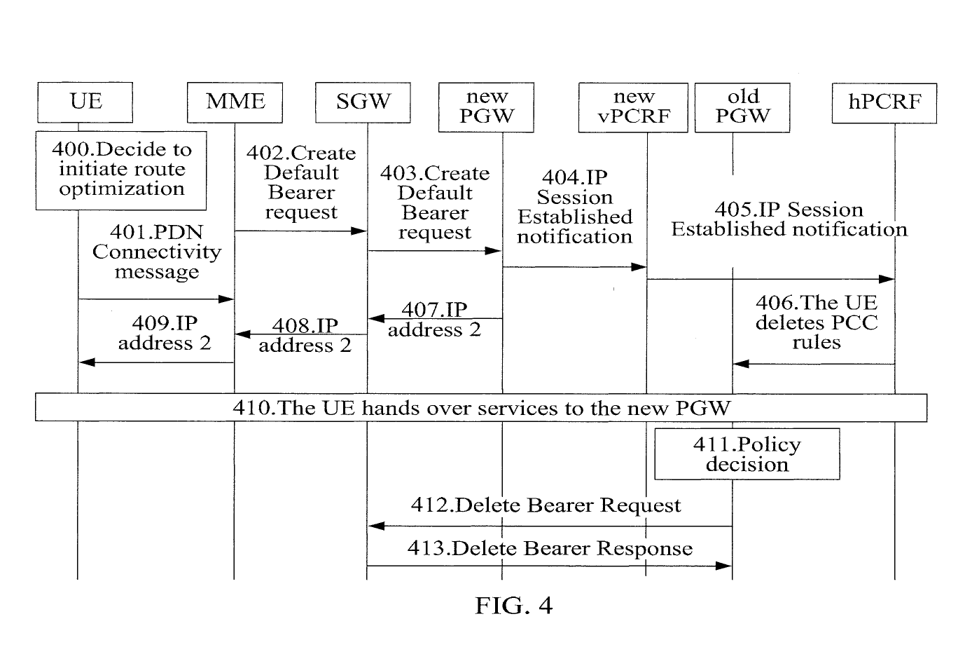

FIG. 4 is a flowchart of a method for optimizing routes provided in Embodiment 4 of the present invention. In this embodiment, the old PGW initiates release of the first PDN connection. The method includes the following steps:

Step 400: The UE decides to initiate route optimization.

Step 401: The UE sends a PDN Connectivity message to the MME. This message includes a reallocation indication.

Step 402: The MME sends a Create Default Bearer message to the SOW. The Create Default Bearer message includes the reallocation indication and the information about the new PGW selected by the MME.

Step 403: The SGW sends a Create Default Bearer message to the selected new PGW.

Step 404: The new PGW allocates a new network address, namely, IP address 2, to the UE. The new PGW sends an IP Session Established notification message to the new vPCRF, indicating that the UE has established the second PDN connection.

Step 405: The new vPCRF sends an IP Session Established notification message to the hPCRF so that the hPCRF knows that the UE has established the second PDN connection.

Steps 400-405 are similar to steps 200-205.

Step 406: The hPCRF sends a message for deleting PCC rules to the old PGW.

The hPCRF finds that two PDN connections exist locally for the same APN “cmims”, and delivers a policy command to the old PGW to trigger the old PGW to delete the corresponding PCC rules.

Step 407: The new PGW sends a message that includes IP address 2 to the SOW. Step 206 is performed after the new PGW allocates a new network address, namely, IP address 2, to the UE, and step 206 may be performed before, while or after the new PGW sends the IP Session Established message to the new vPCRF.

Step 408: The SGW sends a message that includes IP address 2 to the MME.

Step 409: The MME sends the message that includes IP address 2 to the UE.

Step 410: After receiving the message that includes IP address 2, the UE knows that the new PDN connection has been established, and the new network address is IP address 2. In this way, the service is handed over to the new PDN.

Steps 407-410 are similar to steps 206-209.

Step 411: The old PGW makes a policy decision.

According to a local policy, the old PGW makes a policy decision. It is assumed that the local policy is a time policy. After a period such as 12 hours, the old PGW finds that the first PDN connection corresponding to the PCC rules which the hPCRF expects to delete is not released. In this case, the old PGW performs the corresponding operations, for example, sends a Delete Bearer Request message to the SGW to delete the first PDN connection.

Step 412: The old PGW sends a Delete Bearer Request message to the SGW.

Step 413: The SGW releases the corresponding resources, and sends a Delete Bearer Response message to the old PGW, thus releasing the first PDN connection.

In conclusion, in this embodiment, the UE sends a route optimization request that includes a network address reallocation indication, and the network establishes an after-route-optimization second PDN connection for the UE, and the existing first PDN connection is reserved while the second PDN connection is established. In this way, the existing data gateway and address are reserved when the service is provided through a new PGW. Therefore, the service continuity is ensured in the process of route optimization. In addition, the first PDN connection may be released after the UE hands the service over to the new PGW, thus releasing the system resources occupied by the UE and improving the utilization ratio of system resources.

FIG. 5 is a flowchart of a method for optimizing routes provided in Embodiment 5 of the present invention. In this embodiment, the current vPCRF (old vPCRF) initiates release of the first PDN connection. The method includes the following steps:

Step 500: The UE decides to initiate route optimization.

Step 501: The UE sends a PDN Connectivity message to the MME. This message includes a reallocation indication.

Step 502: The MME sends a Create Default Bearer message to the SGW. The Create Default Bearer message includes the reallocation indication and the information about the new PGW selected by the MME.

Step 503: The SGW sends a Create Default Bearer message to the selected new PGW.

Step 504: The new PGW allocates a new network address, namely, IP address 2, to the UE.

The new PGW sends an IP Session Established notification message to the new vPCRF, indicating that the UE has established the second PDN connection.

Step 505: The new vPCRF sends an IP Session Established notification message to the hPCRF so that the hPCRF knows that the UE has established the second PDN connection.

Steps 500-505 are similar to steps 200-205.

Step 506: The hPCRF sends a message for deleting PCC rules to the old vPCRF.

The hPCRF finds that two PDN connections exist locally for the same APN “cmims”, and delivers a policy command to the old PGW to trigger the old PGW to delete the corresponding PCC rules.

Step 507: The new PGW sends a message that includes IP address 2 to the SGW. Step 206 is performed after the new PGW allocates a new network address, namely, IP address 2, to the UE, and step 206 may be performed before, while or after the new PGW sends the IP Session Established message to the new vPCRF.

Step 508: The SGW sends a message that includes IP address 2 to the MME.

Step 509: The MME sends the message that includes IP address 2 to the UE.

Step 510: After receiving the message that includes IP address 2, the UE knows that the new PDN connection has been established, and the new network address is IP address 2. In this way, the service is handed over to the new PGW.

Steps 507-510 are similar to steps 206-209.

Step 511: The old vPCRF makes a policy decision.

According to a local policy, the old vPCRF makes a policy decision. It is assumed that the local policy is a time policy. After a period such as 12 hours, the old vPCRF finds that the first PDN connection corresponding to the PCC rules which the hPCRF expects to delete is not released. In this case, the old PGW performs the corresponding operations, for example, sends a Delete PCC Rules message to the old PGW to trigger the old PGW to delete the first PDN connection.

Step 512: The old vPCRF sends a message for deleting PCC rules to the old PGW.

Step 513: The old PGW sends a Delete Bearer Request message to the SGW.

Step 514: The SGW releases the corresponding resources, and sends a Delete Bearer Response message to the old PGW, thus releasing the first PDN connection.

In conclusion, in this embodiment, the UE sends a route optimization request that includes a network address reallocation indication, and the network establishes an after-route-optimization second PDN connection for the UE, and the existing first PDN connection is reserved while the second PDN connection is established. In this way, the existing data gateway and address are reserved when the service is provided through a new PGW. Therefore, the service continuity is ensured in the process of route optimization. In addition, the first PDN connection may be released after the UE hands the service over to the new PGW, thus releasing the system resources occupied by the UE and improving the utilization ratio of system resources.

FIG. 6 is a signaling flowchart of a method for optimizing routes provided in Embodiment 6 of the present invention. This embodiment deals with a method for optimizing routes when the UE accesses the PGW through a Worldwide Interoperability for Microwave Access (WiMax) network. The method includes the following steps:

Step 600: The UE decides to initiate route optimization.

Step 601: The UE sends a tunnel establishment message to an access control entity “ePDG” in the WiMax network. The message includes an IP address reallocation indication, and serves as a route optimization request.

Step 602: The ePDG sends a Proxy Binding Update message to the selected new PGW, and the new PGW may be selected by the ePDG.

Step 603: The new PGW allocates a new network address, namely, IP address 2, to the UE, and sends an IP Session Established notification message to the new vPCRF, indicating that the UE has established the second PDN connection.

Step 604: The new vPCRF sends an IP Session Established notification message to the hPCRF so that the hPCRF knows that the UE has established the second PDN connection.

After knowing that the UE has established the second PDN connection, the hPCRF may deliver a policy command to the old PGW to trigger the old PGW to delete the corresponding PCC rules.

Step 605: The new PGW sends a Proxy Binding Update response message to the ePDG. The response message includes IP address 2 and may be a Proxy Binding Ack message.

Step 606: The ePDG sends IP address 2 to the UE.

Step 607: After receiving the message that includes IP address 2, the UE knows that the new PDN connection has been established, and the new network address is IP address 2. In this way, the service is handed over to the new PGW.

Step 608: The ePDG makes a policy decision.

According to a local policy, the ePDG makes a policy decision. It is assumed that the local policy is a time policy. After a period such as 12 hours, the ePDG finds that two PDN connections still exist locally for the APN “cmims” of the UE. In this case, the ePDG may perform the corresponding operations. For example, a disconnection trigger message is sent to the old PGW to delete the first PDN connection.

Step 609: The ePDG sends a Proxy Binding Update message to the old PGW. The lifetime parameter in the message is set to 0 so that the message serves as a disconnection trigger message.

Step 610: The old PGW sends a Proxy Binding Update response message to the ePDG, thus releasing the first PDN connection.

In conclusion, in this embodiment, the UE sends a route optimization request that includes a network address reallocation indication to an access control entity “ePDG” in the WiMax network, and the network establishes an after-route-optimization second PDN connection for the UE, and the existing first PDN connection is reserved while the second PDN connection is established. In this way, the existing data gateway and address are reserved when the service is provided through a new PGW. Therefore, the service continuity is ensured in the process of route optimization. In addition, the first PDN connection may be released after the UE hands the service over to the new PGW, thus releasing the system resources occupied by the UE and improving the utilization ratio of system resources.

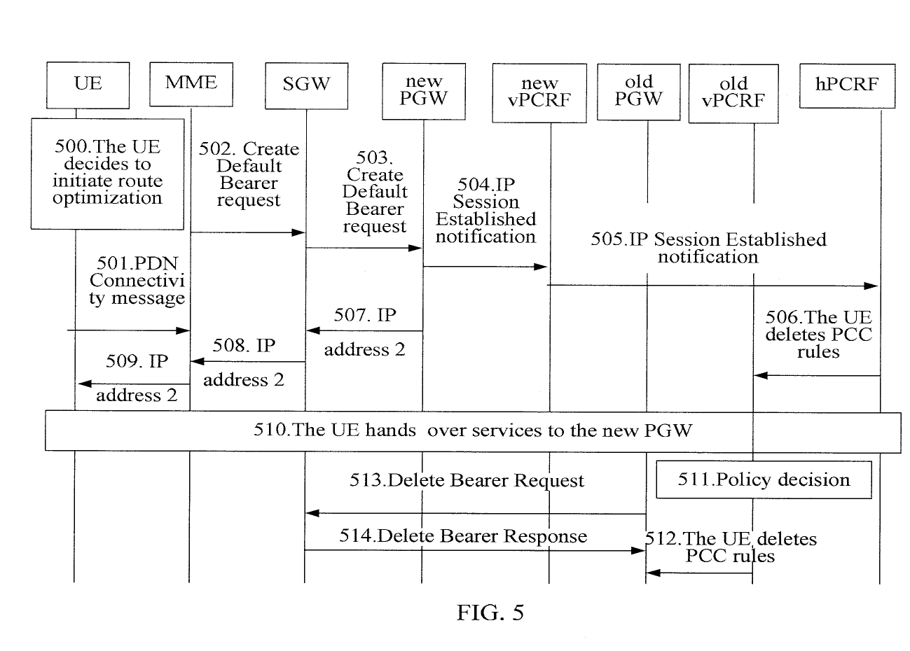

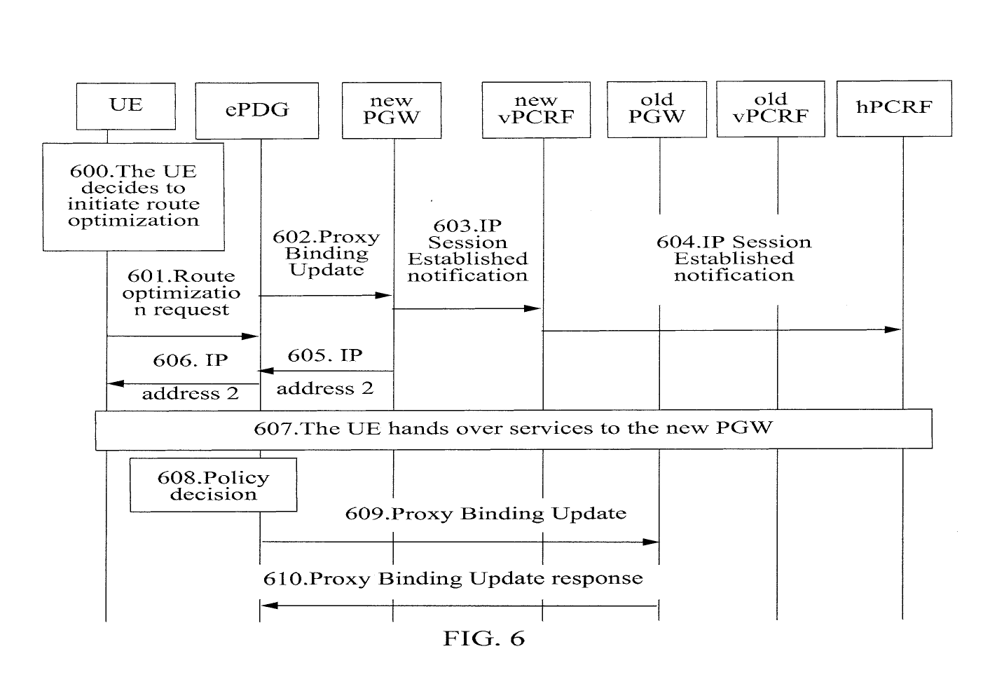

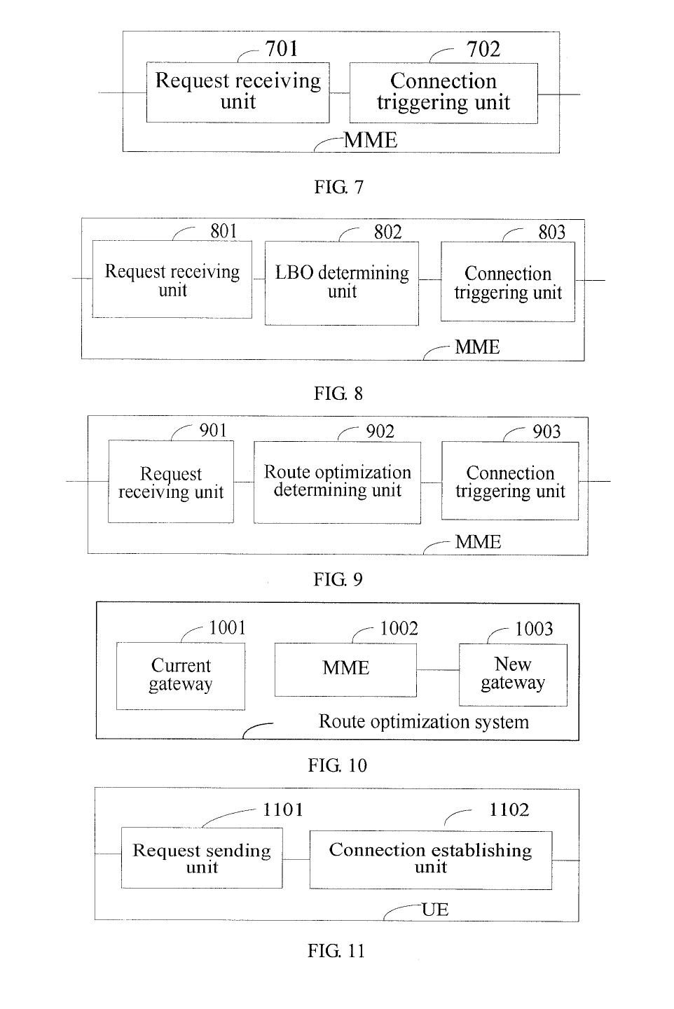

FIG. 7 shows a structure of an MME in Embodiment 1 of the present invention. The MME includes:

a request receiving unit 701, configured to receive a route optimization request that includes a network address reallocation indication, where the route optimization request is sent by a UE when a first PDN connection exists between the UE and an old gateway; and

a connection triggering unit 702, configured to trigger establishment of a second PDN connection between the UE and a new gateway according to the network address reallocation indication.

Specifically, a trigger message may be sent to other network entities according to the network address reallocation indication. The trigger message varies with the type of network or scenario. For example, the trigger message is a PDN connection establishment request to the SGW as a request for establishing the second PDN connection.

In this embodiment, after the route optimization request that includes the network address reallocation indication is received, a second PDN connection is established according to the network address reallocation indication. In this way, in the process of route optimization, the after-route-optimization second PDN connection is established, and the existing first PDN connection is reserved at the time of establishing the second PDN connection; two PDN connections can be established for one access point. Therefore, the service of the UE can be handed over to the new gateway through the second PDN connection, and the service continuity is ensured in the process of route optimization.

In this embodiment, after the route optimization request is received from the UE, a route optimization process is initiated. Here it is assumed that the route optimization request sent by the UE is a PDN Connectivity message. After the request receiving unit 701 of the MME receives the PDN Connectivity message, the connection triggering unit 702 triggers establishment of a second PDN connection to the new PGW according to the reallocation indication carried in the PDN Connectivity message. Specifically, according to the reallocation indication, the connection triggering unit 702 sends a trigger message to the corresponding SGW to trigger establishment of the second PDN connection. The sent trigger message varies with the type of network or use environment.

As shown in FIG. 8, an MME provided in Embodiment 2 of the present invention includes:

a request receiving unit 801, configured to receive a route optimization request that includes a network address reallocation indication, where the route optimization request is sent by a UE when a first PDN connection exists between the UE and an old gateway;

a LBO determining unit 802, configured to determine whether the UE is allowed to use LBO after the request receiving unit 801 receives the route optimization request, where: specifically, the judgment may be made according to the APN corresponding to the UE; and

a connection triggering unit 803, configured to trigger establishment of a second PDN connection between the UE and a new gateway according to the network address reallocation indication if the LBO determining unit 802 determines that the UE is allowed to use LBO.

Compared with Embodiment 1 of the MME, the MME in this embodiment further includes a LBO determining unit, and therefore, the second PDN connection is established only for the UE which is allowed to use LBO, and the system resources are made full use of.

After receiving the route optimization request sent by the UE, the MME in this embodiment initiates a route optimization process. Here it is assumed that the route optimization request sent by the UE is a PDN Connectivity message. The request receiving unit 801 of the MME receives the PDN Connectivity message. The PDN Connectivity message may carry a reallocation indication and an APN. In this case, the LBO determining unit 802 may determine whether the UE is allowed to use LBO according to the APN, and specifically, may query the corresponding database according to the APN. The connection triggering unit 803 trigger establishment of a second PDN connection between the UE and a new gateway according to the network address reallocation indication carried in the PDN Connectivity message if the LBO determining unit 802 determines that the UE is allowed to use LBO. Specifically, according to the reallocation indication, the connection triggering unit 803 may send a trigger message to the corresponding SGW to trigger establishment of the second PDN connection. The sent trigger message varies with the type of network or use environment.

As shown in FIG. 9, an MME provided in Embodiment 3 of the present invention includes:

a request receiving unit 901, configured to receive a route optimization request that includes a network address reallocation indication, where the route optimization request is sent by a UE when a first PDN connection exists between the UE and an old gateway;

a route optimization determining unit 902, configured to determine whether the new gateway is better than the old gateway after the request receiving unit 901 receives the route optimization request; and

a connection triggering unit 903, configured to trigger establishment of a second PDN connection between the UE and the new PGW according to the network address reallocation indication if the route optimization determining unit 902 determines that a new gateway is better than the old gateway.

Compared with Embodiment 1 of the MME, the MME in this embodiment further includes a route optimization determining unit, and therefore, the second PDN connection is established only for the UE which requires route optimization, and the system resources are made full use of.

After receiving the route optimization request sent by the UE, the MME in this embodiment initiates a route optimization process. Here it is assumed that the route optimization request sent by the UE is a PDN Connectivity message. The request receiving unit 901 of the MME receives the PDN Connectivity message. The PDN Connectivity message may carry a reallocation indication. In this case, the route optimization determining unit 902 may determine whether a new gateway is better than the old gateway, and specifically, make the judgment according to the location of the UE and the network that covers the UE. The connection triggering unit 903 trigger establishment of a second PDN connection between the UE and the new gateway according to the network address reallocation indication carried in the PDN Connectivity message if the route optimization determining unit 902 determines that a new gateway is better than the old gateway. Specifically, according to the reallocation indication, the connection triggering unit 903 may send a trigger message to the corresponding SGW to trigger establishment of the second PDN connection. The sent trigger message varies with the type of network or use environment.

It should be noted that the LBO determining unit in Embodiment 2 of the MME and the route optimization determining unit in Embodiment 3 of the MME may exist in the same MME. In this case, the LBO determining unit and the route optimization determining unit may be the same determining unit, or two different units in the MME.

A system for optimizing routes is provided in an embodiment of the present invention. As shown in FIG. 10, a system for optimizing routes provided in this embodiment of includes:

an old gateway 1001, configured to establish a first PDN connection to a UE;

an MME 1002, configured to: receive a route optimization request that includes a network address reallocation indication, where the route optimization request is sent by the UE when a first PDN connection exists between the UE and the old gateway; and send a trigger message according to the network address reallocation indication; and

a new gateway 1003, configured to establish a second PDN connection according to the trigger message sent by the MME.

In this embodiment, the UE sends a route optimization request that includes a network address reallocation indication, the network establishes an after-route-optimization second PDN connection for the UE; the existing first PDN connection can be reserved while the second PDN connection is established; in the process of route optimization, two PDN connections can be established for one access point. Therefore, the service of the UE can be handed over to the new gateway through the second PDN connection, and thus the service continuity is ensured in the process of route optimization.

In the case that a first PDN connection already exists between the old gateway 1001 and the UE, if the UE needs to initiate route optimization, the UE sends a route optimization request to the MME. Here it is assumed that the route optimization request is a PDN Connectivity message. After receiving the PDN Connectivity message, the MME 1002 sends a trigger message to the new gateway according to the PDN Connectivity message. The new gateway 1003 establishes the second PDN connection according to the trigger message. The trigger message sent by the MME 1002 varies with the type of network or use environment.

Further, the MME in the system for optimizing routes in this embodiment may determine whether the UE sending the route optimization request is allowed to use LBO after receiving the route optimization request, and sends a trigger message only if the UE is allowed to use LBO. Because the second PDN connection is established according to the trigger message only if the UE is allowed to use LBO, the system resources are made full use of. The MME may determine the LBO right of the UE according to the APN, and specifically, by searching a database according to the APN.

Further, the MME in the system for optimizing routes in this embodiment may determine whether a new gateway is better than the old gateway after receiving the route optimization request, and sends a trigger message only if a new gateway is better than the old gateway. Because the second PDN connection is established according to the trigger message only if a new gateway is better than the old gateway, the second PDN connection is established only if route optimization is required, and the system resources are made full use of. The MME may determine whether a new gateway is better than the old gateway according to the location and environment of the UE.

Further, the old gateway in the system for optimizing routes provided in this embodiment is further configured to release the first PDN connection after the second PDN connection is established between the new gateway and the UE. After the second PDN connection is established, the UE has handed over the service to the new gateway through the second PDN connection, and the first PDN connection can be released. By releasing the system resources occupied by the first PDN connection, this embodiment makes full use of the system resources. The old gateway may release the first PDN connection actively according to its own policy, or release the first PDN connection passively according to a trigger message sent by another network entity, for example, according to a Delete PCC Rules message sent by the old vPCRF.

An apparatus for implementing the method for optimizing routes is provided in an embodiment of the present invention. FIG. 11 shows a structure of a UE provided in an embodiment of the present invention. The UE includes:

a request sending unit 1101, configured to send a route optimization request that includes a network address reallocation indication when the UE has a first PDN connection; and

a connection establishing unit 1102, configured to establish a second PDN connection to the new gateway after the request sending unit 1101 sends the route optimization request.

Specifically, the second PDN connection may be established after the new network address is received.

In this embodiment, the UE sends a route optimization request that includes a network address reallocation indication, the network establishes a second PDN connection for the UE; in the process of route optimization, an after-route-optimization PDN connection is established for an APN; the existing first PDN connection can be reserved while the second PDN connection is established; two PDN connections can be established for one access point at the same time. Therefore, the service of the UE can be handed over to the new gateway through the second PDN connection, and thus the service continuity is ensured in the process of route optimization.

Through the UE in this embodiment, after it is determined that route optimization is required, the request sending unit 1101 sends a PDN Connectivity message as a route optimization request to the MME, and the message includes a reallocation indication to initiate route optimization; the MME is triggered to perform a route optimization process, and the new gateway allocates a new network address to the UE; after obtaining the new network address, the MME sends the new network address to the UE; after the UE obtains the new network address, the connection establishing unit 1102 uses the new network address to establish a second PDN connection to the new gateway. Generally, the establishment of the second PDN connection is completed after the UE obtains the new network address.

Further, the UE may include a service handover unit, which is configured to hand over the service to the new gateway through the second PDN connection after the connection establishing unit establishes the second PDN connection. After the service of the UE is handed over to the new gateway, the UE can use the new gateway to carry out services, and the UE can obtain better services.

Further, to release the system resources occupied by the UE, the UE in this embodiment may include:

a connection releasing unit, configured to release the first PDN connection after the service handover unit hands the service over to the new gateway. After the first PDN connection is released, the system resources occupied by the first PDN connection may be released so that the system resources are made full use of.

Persons of ordinary skill in the art understand that all or part of the steps of the method specified in any of the embodiments above may be implemented by a program instructing relevant hardware. The program may be stored in a computer readable storage medium. When the program runs, at least the following steps are performed:

receiving a route optimization request that includes a network address reallocation indication, where the route optimization request is sent by a UE when a first PDN connection exists between the UE and an old gateway; and

triggering establishment of a second PDN connection between the UE and a new gateway according to the network address reallocation indication.

The storage medium may be Read Only Memory (ROM), magnetic disk, or CD-ROM.

Elaborated above are a method, a system, and an apparatus for implementing route optimization under the present invention. Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for optimizing routes, comprising:
receiving a route optimization request that includes a network address reallocation indication, wherein the route optimization request is sent by User Equipment (UE) when a first Packet Data Network (PDN) connection exists between the UE and an old gateway; and
triggering establishment of a second PDN connection between the UE and a new gateway according to the network address reallocation indication.

2. The method for optimizing routes according to claim 1, wherein:
after the second PDN connection is established, handing over services of the UE to the new gateway through the second PDN connection.

3. The method for optimizing routes according to claim 1, wherein: before triggering establishment of the second PDN connection between the UE and the new gateway according to the network address reallocation indication, the method further comprises:
determining whether the UE is allowed to use Local Break Out (LBO); and
establishing the second PDN connection according to the network address reallocation indication if the UE is allowed to use the LBO.

4. The method for optimizing routes according to claim 1, wherein: before triggering establishment of the second PDN connection between the UE and the new gateway according to the network address reallocation indication, the method further comprises:
determining whether the new gateway is better than the old gateway; and
establishing the second PDN connection according to the network address reallocation indication if the new gateway is better than the old gateway.

5. The method for optimizing routes according to claim 2, wherein: after handing over the services of the UE to the new gateway through the second PDN connection, the method further comprises one of the followings:
releasing, by the UE, the first PDN connection; and
releasing, by the old gateway, the first PDN connection.

6. The method for optimizing routes according to claim 5, wherein the releasing, by the old gateway, the first PDN connection comprises:
releasing, by the old gateway, the first PDN connection according to its own policy.

7. The method for optimizing routes according to claim 5, wherein the releasing, by the old gateway, the first PDN connection comprises:
receiving, by the old gateway, a disconnection indication sent by a release initiating unit in a network according to its own policy; and
releasing the first PDN connection according to the disconnection indication.

8. The method for optimizing routes according to claim 7, wherein:
the release initiating unit is one of the followings: a Serving Gateway (SGW), a Mobility Management Entity (MME), a visited area Policy Control and Charging Rules Function (vPCRF), and a home Policy Control and Charging Rules Function (hPCRF).

9. The method for optimizing routes according to claim 2, wherein: before triggering establishment of the second PDN connection between the UE and the new gateway according to the network address reallocation indication, the method further comprises:
determining whether the new gateway is better than the old gateway; and
establishing the second PDN connection according to the network address reallocation indication if the new gateway is better than the old gateway.

10. A Mobility Management Entity (MME), comprising:
a request receiving unit, configured to receive a route optimization request comprising a network address reallocation indication, wherein the route optimization request is sent by User Equipment (UE) when a first Packet Data Network (PDN) connection exists between the UE and an old gateway; and
a connection triggering unit, configured to trigger establishment of a second PDN connection between the UE and a new PDN Gateway (PGW) according to the network address reallocation indication received by the request receiving unit.

11. The MME according to claim 10, further comprising:
a LBO determining unit, configured to determine whether the UE is allowed to use the Local Break Out (LBO) after the request receiving unit receives the route optimization request, wherein:
the connection triggering unit is configured to trigger establishment of the second PDN connection according to the network address reallocation indication received by the request receiving unit if the LBO determining unit determines that the UE is allowed to use the LBO.

12. The MME according to claim 10, further comprising:
a route optimization determining unit, configured to determine whether the new gateway is better than the old gateway after the request receiving unit receives the route optimization request, wherein:
the connection triggering unit is configured to trigger establishment of the second PDN connection according to the network address reallocation indication if the route optimization determining unit determines that the new gateway is better than the old gateway.

13. A system for optimizing routes, comprising:
an old gateway, configured to establish a first Packet Data Network (PDN) connection to a User Equipment (UE);
a Mobility Management Entity (MME), configured to receive a route optimization request comprising a network address reallocation indication, wherein the route optimization request is sent by the UE when the first PDN connection exists between the UE and an old gateway; and send a trigger message according to the network address reallocation indication; and
a new gateway, configured to establish a second PDN connection to the UE according to the trigger message sent by the MME.

14. The system for optimizing routes according to claim 13, wherein:
the MME is further configured to determine whether the UE is allowed to use the LBO after receiving the route optimization request; and
send the trigger message if the UE is allowed to use the LBO.

15. The system for optimizing routes according to claim 13, wherein:
the MME is further configured to determine whether the new gateway is better than the old gateway after receiving the route optimization request; and
send the trigger message if the new gateway is better than the old gateway.

16. The system for optimizing routes according to claim 13, wherein:
the old gateway is further configured to release the first PDN connection after the new gateway establishes the second PDN connection.

17. The system for optimizing routes according to claim 15, wherein:
the old gateway is further configured to release the first PDN connection after the new gateway establishes the second PDN connection.

18. A User Equipment (UE), comprising:
a request sending unit, configured to send a route optimization request comprising a network address reallocation indication when a first Packet Data Network (PDN) connection to an old gateway exists; and
a connection establishing unit, configured to establish a second PDN connection to a new gateway after the request sending unit sends the route optimization request.

19. The UE according to claim 18, further comprising:
a service handover unit, configured to hand over services to the new gateway through the second PDN connection after the connection establishing unit establishes the second PDN connection.

20. The UE according to claim 19, further comprising:
a connection releasing unit, configured to release the first PDN connection after the service handover unit hands the services over to the new gateway.
